(19) United States
(12) Patent Application Publication
(10) Pub. No.: US 2019/0307634 A1
(43) Pub. Date: Oct. 10, 2019

(54) MASSAGE MACHINE

(71) Applicant: FAMILY INADA CO., LTD., Osaka (JP)

(72) Inventor: Atsushi Moritomo, Tottori (JP)

(21) Appl. No.: 16/378,032

(22) Filed: Apr. 8, 2019

(30) Foreign Application Priority Data
Apr. 9, 2018 (JP) 2018-075077

(51) Int. Cl. A61H 15/00; A61H 23/04

(52) U.S. Cl. CPC A61H 15/0078; A61H 23/04; A61H 2201/0149; A61H 2205/081; A61H 2201/0103; A61H 2201/5028; A61H 2203/0431; A61H 2201/5061; A61H 2201/1238

(57) ABSTRACT

A massage machine includes a backrest unit, a massage unit disposed in the backrest unit and a control unit. The massage unit is movable in a height direction and includes a treatment element that applies treatment onto a user, a first sensor configured to detect a first site of the user based on a load received from the user according to the movement of the massage unit and a second sensor configured to detect a second site of the user based on a movement of the treatment element according to the movement of the massage unit. The control unit is configured to control the massage unit so that the first sensor detects the first site of the user during the movement of the massage unit from an initial position, and the second sensor detects the second site of the user during the massage being in progress.

### RELATED APPLICATION

This application claims the Paris Convention priority based on Japanese Application No. 2018-075077 filed on Apr. 9, 2018, the contents of which, including the specification, the claims and the drawings, are incorporated herein by reference in their entirety.

### TECHNICAL FIELD

The present invention relates to a massage machine.

### BACKGROUND ART

In the related art, a massage machine has been proposed which detects a shoulder position of a user by moving a massage unit along a backrest (for example, refer to Japanese Unexamined Patent Publication No. 2003-339810).

### SUMMARY OF THE INVENTION

The invention of this application relates to a massage machine that includes a backrest unit on which a user is configured to lean, a massage unit that is disposed in the backrest unit that performs a massage on the user, and a control unit that controls the massage unit. The massage unit is movable in a height direction and includes a treatment element that is configured to apply treatment onto the user. The massage unit includes a first sensor and a second sensor. The first sensor is configured to detect a first site of the user based on a load received from the user according to a movement of the massage unit in the height direction. The second sensor is configured to detect a second site of the user based on a movement of the treatment element according to the movement of the massage unit in the height direction. The control unit is configured to control the massage unit that: the first sensor detects the first site of the user during the movement of the massage unit from an initial position, and the second sensor detects the second site of the user during the massage being in progress. The second sensor may detect the second site during the movement of the massage unit toward the first site.

The first site may be a shoulder position of the user. The second site may be a shoulder position of the user. The first sensor may detect a load of a drive unit that moves the treatment element in the height direction. The control unit may control forward-rearward moving means to move the massage unit forward or rearward. The massage machine may have a notification unit that notifies the user of the second site.

### BRIEF DESCRIPTION OF THE DRAWINGS

FIG. 1 is a front perspective view of a massage machine according to a first embodiment of the present invention.

FIG. 2 is a schematic view of the massage machine according to the first embodiment of the present invention.

FIG. 3 is a functional block diagram of the massage machine.

FIG. 4 is a side view for describing a posture of the massage machine.

FIG. 5 is a front view of a massage unit.

FIG. 6 is a view when a motor is viewed in an axial direction of an output shaft.

FIG. 7 is a view for describing a control of the motor in accordance with a detection result of a sensor.

FIG. 8 is a flowchart illustrating a control of the massage machine.

FIG. 9 is a flowchart illustrating a control of the massage machine.

### DETAILED DESCRIPTION OF THE INVENTION

According to the present invention, there is provided a massage machine including a backrest unit on which a user leans, a massage unit that is disposed in the backrest unit so as to perform a massage on the user, and a control unit that operates the massage unit in accordance with a determined program. The massage unit is movable in a height direction and has a pair of right and left treatment elements, first detection means, which is a sensor, for detecting a load received when the treatment elements move, and second detection means, which is another sensor, for detecting a specific site of a body of the user, based on the movement of the massage unit in the height direction. The control unit has an initial or first detection step of causing the first detection means to detect a first site, or a first specific site of the user, to which the load is applied, in a process of moving the massage unit from an initial position, a massage step of causing the massage unit to perform the massage after the first detection step, and a second detection step of causing the second detection means to detect a second site, or a second specific site of the user, in a process of moving the massage unit toward the first specific site of the user, which is temporarily detected in the first detection step, during the massage step.

According to this configuration, the massage machine enables the user to immediately receive the massage, and can detect the specific site of the user while the user is not conscious of detecting the specific site during the massage.

In addition, in the first detection step, it is preferable that the first detection means detects a shoulder position which is the specific site of the user, to which a prescribed or higher load is applied, in a process of moving the massage unit downward from the initial position.

According to this configuration, the massage machine can detect the shoulder position of the user.

In addition, in the second detection step, it is preferable that the second detection means re-detects the shoulder position which is the specific site of the user, in a process of moving the massage unit upward to the shoulder position of the user which is detected in the first detection step.

According to this configuration, the massage machine can re-detect the shoulder position of the user. For example, the massage machine can detect an accurate position by re-detecting position misalignment caused by a posture change of the user during the massage.

In addition, it is preferable that the massage machine further includes a drive unit that moves the treatment element in the height direction, and that the first detection means detects a load of the drive unit.

According to this configuration, the massage machine can detect the specific site to which the load of the drive unit is applied. For example, the massage machine can detect the shoulder position of the user by using the load of the drive unit.

In addition, it is preferable that the massage machine further includes forward-rearward moving means for moving the massage unit forward and rearward, and that the control unit has a forward moving step of causing the forward-rearward moving means to move the massage unit forward.

According to this configuration, the massage machine moves the massage unit to move forward. In this manner, the massage machine enables the specific site of the user to move forward. For example, the massage machine can more remarkably detect the shoulder position of the user.

In addition, it is preferable that the forward-rearward moving means has an air cell.

According to this configuration, the massage machine enables the specific site of the user to move forward-rearward by inflating and deflating the air cell.

In addition, it is preferable that the massage machine further includes a notification unit that notifies the user of the specific site by using voice, and that the control unit causes the notification unit to notify the user of the specific site of the user, which is detected by the second detection means.

According to this configuration, the massage machine notifies the user of the specific site. In this manner, the user can recognize the specific site during the massage. For example, the user can recognize the shoulder position suitable for the user himself or herself during the massage.

In addition, it is preferable that the massage machine further includes a storage unit and that the control unit has a position operation step of performing a manual operation so as to enable the massage unit to be located at any desired position from the specific site detected in the second detection step, and a storage step of causing the storage unit to store the position located by performing the manual operation in the position operation step, as the specific site.

According to this configuration, the user performs the manual operation so that the massage unit can be located at any desired position. Accordingly, for example, the shoulder position suitable for the user himself or herself can be determined and stored as the specific site.

### Configuration of Massage Machine According to First Embodiment

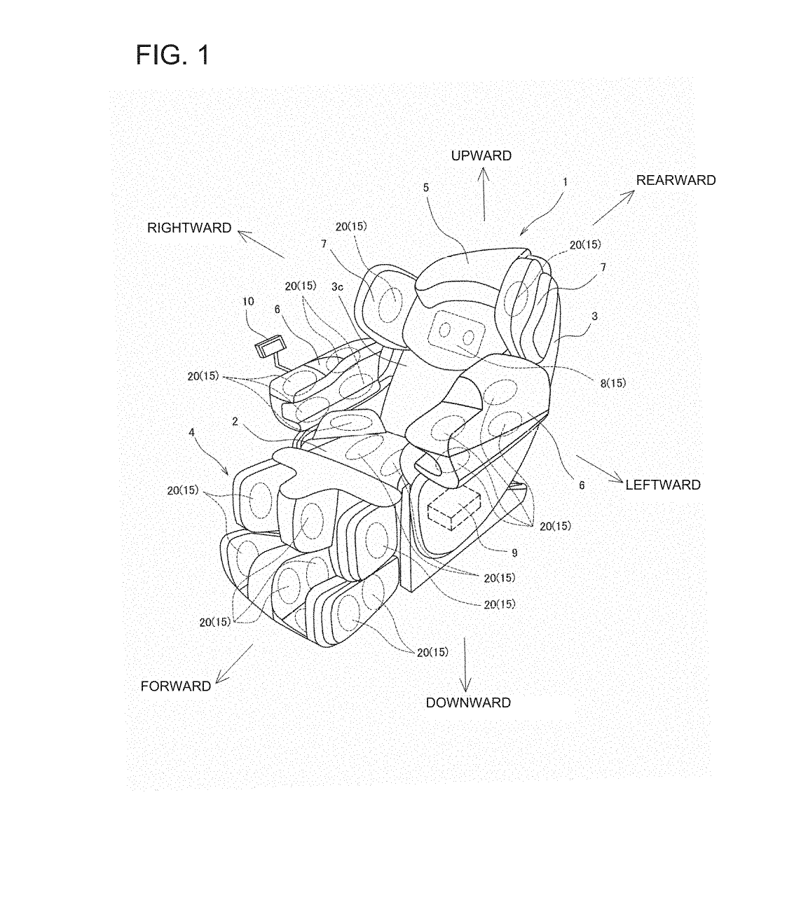

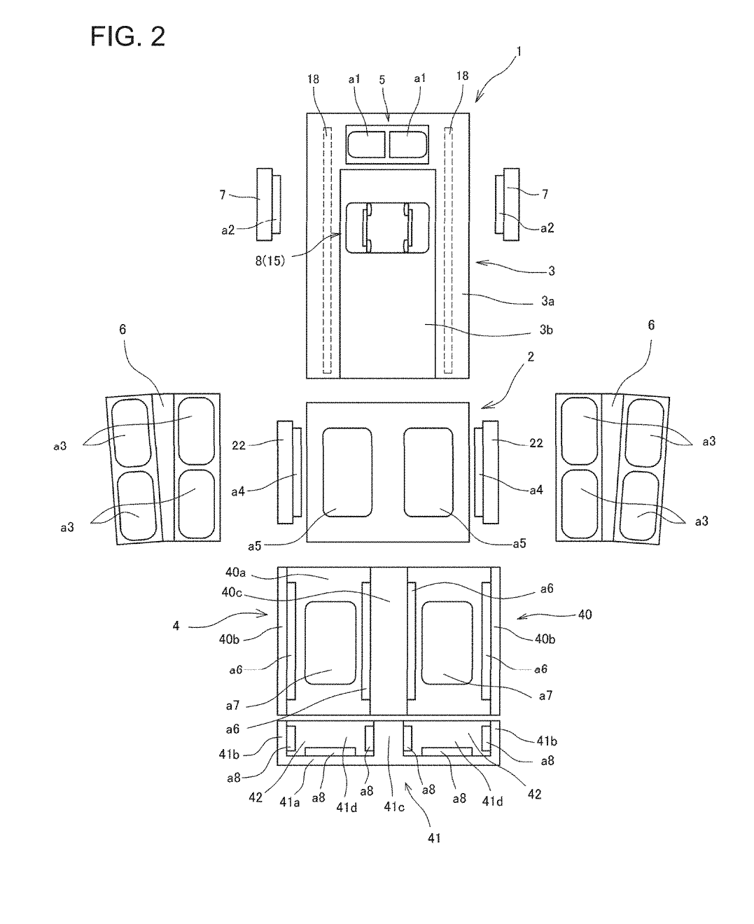

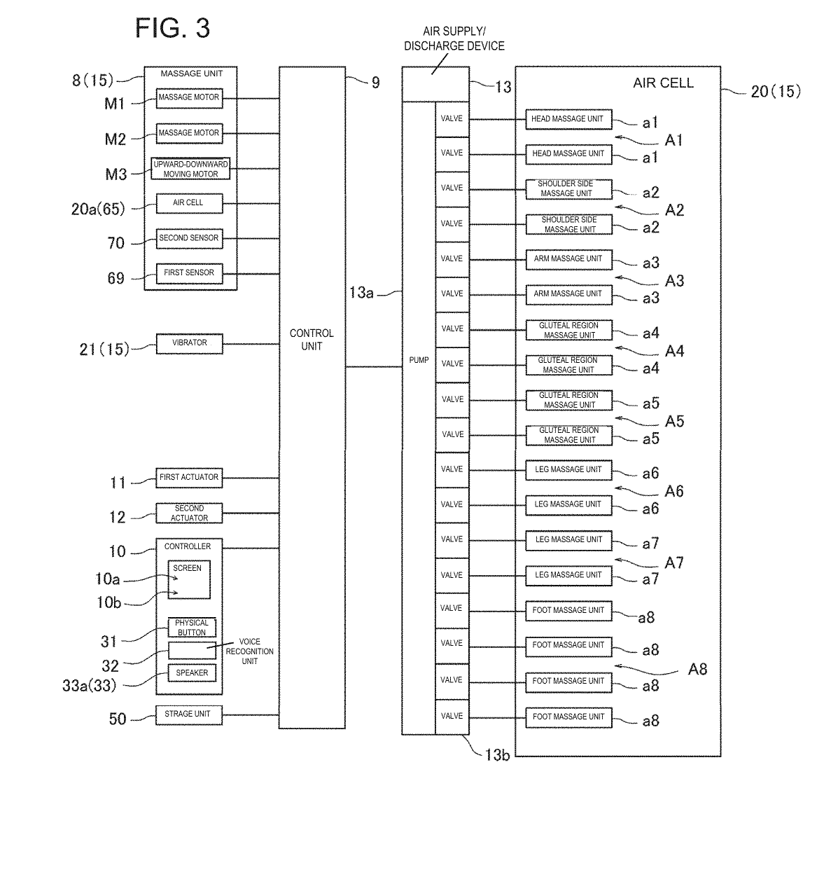

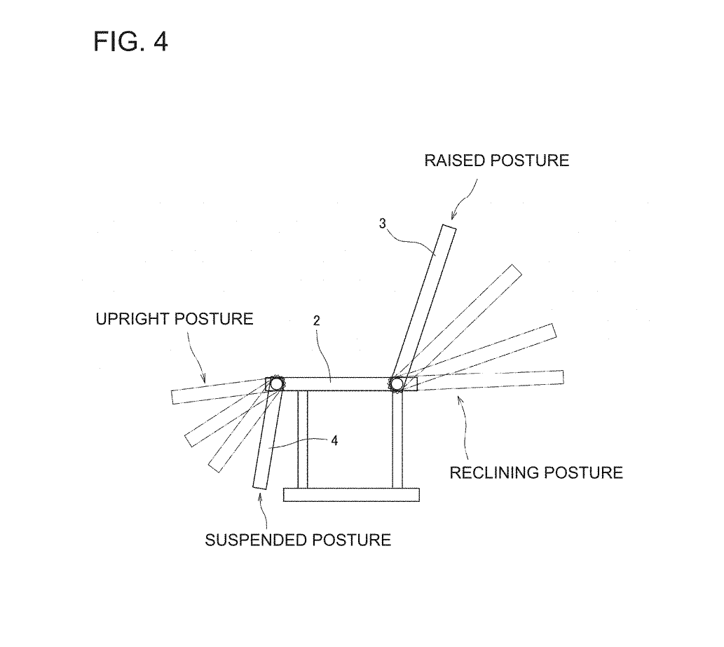

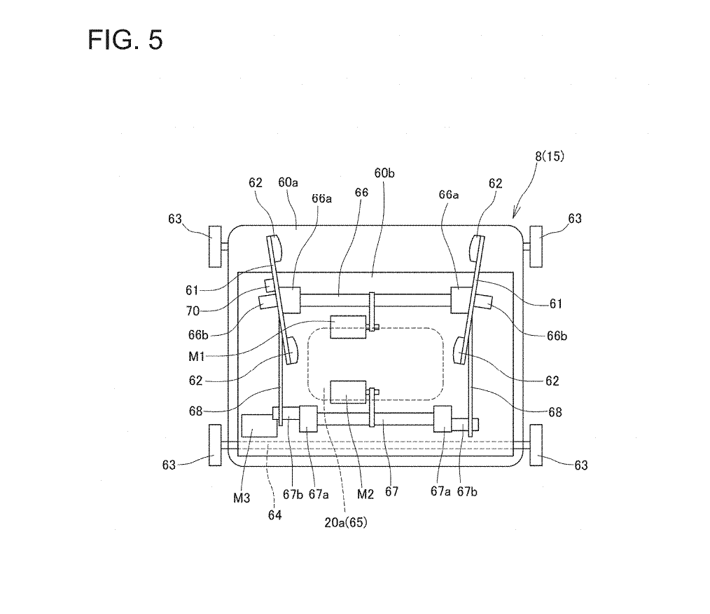

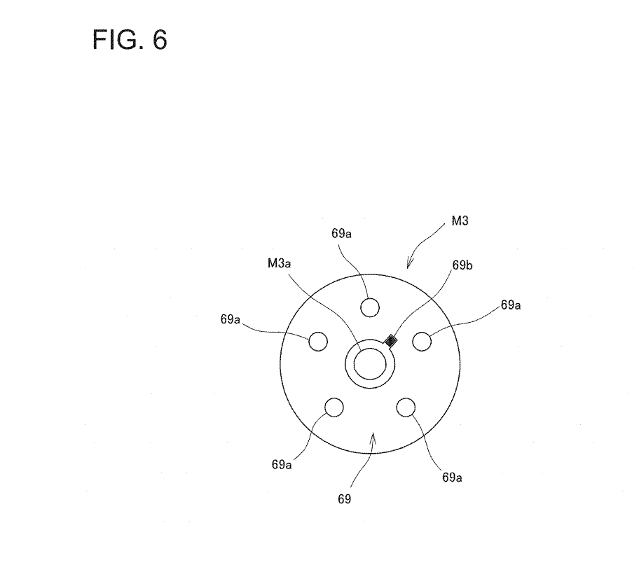

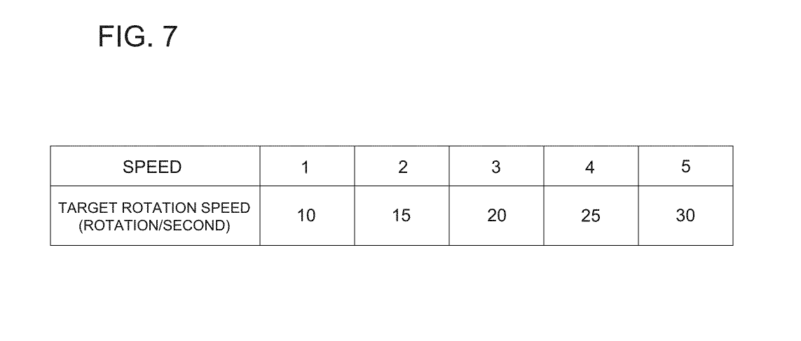

Hereinafter, an overall configuration of a massage machine 1 according to a first embodiment of the present invention will be described. FIG. 1 is a front perspective view of the massage machine 1 according to the first embodiment of the present invention. FIG. 2 is a schematic view of the massage machine 1 according to the first embodiment of the present invention. FIG. 3 is a functional block diagram of the massage machine 1. FIG. 4 is a side view illustrating a posture of the massage machine 1. FIG. 5 is a front view of a massage unit 8. FIG. 6 is a view when an upward-downward moving motor M3 is viewed in an axial direction of an output shaft M3a. FIG. 7 is a view for describing a control of the upward-downward moving motor M3 in accordance with a detection result of a first sensor 69.

A concept of directions used in the following description coincides with a concept of viewing directions of a user when the user sits on the massage machine 1 illustrated in FIG. 1. In other cases, the directions will be appropriately described. In addition, with regard to a definition of a front side and a rear side of a body, description will be made by defining a chest side of the user sitting upright as a “front surface” and defining a back side as a “rear surface”.

### Overall Configuration of Massage Machine

As illustrated in FIGS. 1 to 4, the massage machine 1 according to the first embodiment of the present invention mainly includes a seat unit 2 on which the user sits, a backrest unit 3 which is disposed in a rear part of the seat unit 2 so as to be capable of reclining and on which the user leans, a footrest 4 which is disposed in a front part of the seat unit 2 so as to be capable of oscillating upward and downward and which supports lower limbs of the user, a pillow unit 5 which is disposed on an upper front surface of the backrest unit 3 and which supports a head and/or neck of the user, armrest units 6 disposed on both right and left sides of the seat unit 2, and side wall portions 7 disposed on both right and left sides of the backrest unit 3. The seat unit 2, the backrest unit 3, the footrest 4, the pillow unit 5, the armrest units 6, and the side wall portions 7 function as a body support unit that supports the body of the user. Each place of the body support units 2 to 7 has an air cell 20 (to be described later) for performing a massage on the body of the user, and a massage unit 15 using a vibrator 21 (to be described later). In addition, the massage machine 1 has a massage unit 8 which is a massage unit 15 which performs a kneading massage and/or a patting massage in the backrest unit 3, a control unit 9 which controls each operation of the massage machine 1, and a controller 10 which causes the user to perform various operations (to be described later).

As illustrated in FIGS. 1, 3, and 4, the backrest unit 3 is configured to be capable of reclining forward to and rearward from the seat unit 2 by a first actuator 11 (refer to FIG. 3) disposed below the seat unit 2, and can be changed from an upright posture illustrated in FIG. 1 to a reclining posture (refer to FIG. 4) where a backrest surface is substantially horizontal. The armrest unit 6 is configured to move rearward in conjunction with the reclining posture of the backrest unit 3, and to move forward in conjunction with the upright posture of the backrest unit 3. The footrest 4 is configured to be capable of oscillating upward and downward from the seat unit 2 by a second actuator 12 (refer to FIG. 3) disposed below the seat unit 2, and can be changed change from a suspended posture illustrated in FIG. 1 to a raised posture (refer to FIG. 4) where a lower thigh and a foot are supported in a knee stretched state.

As illustrated in FIGS. 2 and 3, an air supply/discharge device 13 having a pump 13a and a valve 13b for supplying and discharging air to and from each of massage units a1 to a8 having air cells 20 and the above-described control unit 9 are disposed below the seat unit 2. A vibrator 21 driven by a motor may be disposed at a location the same as that of the respective massage units a1 to a8. The air cells 20 can press the user by supplying and discharging the air. The vibrator 21 can vibrate the user by rotating an eccentric weight. The control unit 9 has a programmable microcomputer, and controls to drive the respective actuators 11 and 12, the massage unit 15, and the air supply/discharge device 13. A controller 10 (to be described later) and a storage unit 50 are electrically connected to the control unit 9. The massage machine 1 operates the massage unit 15 in accordance with a predetermined program (massage course) stored in the storage unit 50, and is operated in accordance with an instruction output from the controller 10 by the user (to be described later).

### Configuration of Seat Unit

As illustrated in FIGS. 1 to 3, a wall portion 22 disposed to face an outer surface of gluteal region and/or a femoral region of the user is disposed on the both right and left sides of the seat unit 2. The wall portion 22 is erected upward on a side of the seat unit. An inner surface of the wall portion 22 has a gluteal region massage unit a4 for performing the massage on the outer surface of the gluteal region and/or the femoral region. An inner wall of the armrest unit 6 on both the right and left sides of the seat unit 2 may be used as the wall portion 22, and the gluteal region massage unit a4 may be disposed on an inner wall of the armrest unit. In addition, the seat unit 2 may have a gluteal region massage unit a5 for performing the massage on the gluteal region and/or the femoral region of the user from a lower side (rear surface). The gluteal region massage units a4 and a5 are configured to include the air cell 20 which is inflated and deflated by supplying and discharging the air. In this way, the gluteal region massage units a4 form a pair on the right and left, thereby configuring a massage unit group A4. The gluteal region massage units a5 form a pair on the right and left, thereby configuring a massage unit group A5.

### Configuration of Backrest Unit

As illustrated in FIGS. 1 to 3, the backrest unit 3 is configured to include a rigid back frame 3a, a guide rail 18 for guiding an upward/downward movement of the massage unit 8 which is the massage unit 15 attached to the back frame 3a, and a cover member 3c for covering the back frame 3a. The back frame 3a is configured to include a metal member and/or a resin member. In addition, the back frame 3a has an opening portion 3b which is formed at the center in a rightward-leftward direction and which is open in a forward-rearward direction, and has a substantially gate shape in a front view. In addition, the cover member 3c covers the opening portion 3b from the front. The treatment element 62 (refer to FIG. 5) of the massage unit 8 protrudes forward from the opening portion 3b so that the massage can be performed on the body of the user from the rear via the cover member 3c.

### Configuration of Massage Unit

Hereinafter, a configuration of the massage unit 8 will be described.

As illustrated in FIGS. 1 to 3 and 5, the backrest unit 3 has the massage unit 8 for performing the massage on an upper body of the user from the rear (rear surface). A plurality (one in the present embodiment) of the massage units 8 may be disposed along a height direction. The massage unit 8 is configured to include a pair of right and left arms 61 and the treatment elements 62 disposed in both upper and lower ends of the arm 61. Massage motors M1 and M2 are driven, thereby enabling a kneading massage in which the right and left treatment elements 62 move close to or move away from each other and a patting massage in which the right and left treatment elements 62 alternately move forward to or move rearward from the user side. In addition, the massage unit 8 can move upward or downward along the height direction by driving an upward-downward moving motor M3. In this manner, a position relative to the body can be changed, or a rolling massage can be performed. The back frame 3a has a pair of right and left guide rails 18 extending in the height direction, and the massage unit 8 moves along the guide rails 18. Since the massage unit 8 is movable in the height direction, the treatment element 62 can perform the massage from the neck to the waist of the user.

As illustrated in FIG. 5, the massage unit 8 has a base frame 60a and a movable frame 60b supported by the base frame 60a. The base frame 60a has a guide roller 63 which is fitted to the guide rail 18 on the right and left sides. The base frame 60a can move along the height direction by an upward-downward moving mechanism (not illustrated) having a rack pinion. The movable frame 60b is supported by the base frame 60a via an oscillation shaft 64 in a rightward-leftward direction. Forward-rearward moving means 65 having an air cell 20a is disposed between the base frame 60a and the movable frame 60b. The movable frame 60b can move forward and rearward in the forward-rearward direction around the oscillation shaft 64 by inflating and deflating the air cell 20a which is the forward-rearward moving means 65, and is movable forward to and rearward from a specific site of the user. A structure which moves the movable frame 60b forward and rearward may not be adopted. Alternatively, a structure which moves only the arm 61 forward and rearward by disposing the forward-rearward moving means 65 in the arm 61 may be adopted.

The arm 61 is connected to a kneading shaft 66 and a patting shaft 67 which extend in the rightward-leftward direction. An inclined cam 66a having an inclined shaft portion 66b is disposed on the right and left sides of the kneading shaft 66, and the arm 61 is attached to the inclined cam 66a. The right and left inclined shaft portions 66b are inclined with respect to an axis of the kneading shaft 66 so as to have a substantially inverted V-shape in a front view. An eccentric cam 67a having an eccentric shaft portion 67b eccentric with respect to the axis of the patting shaft 67 is disposed on the right and left sides of the patting shaft 67. The arm 61 is attached to the eccentric cam 67a via a connecting rod 68. The right and left eccentric shaft portions 67b have mutually different phases with respect to the axis of the patting shaft 67. Specifically, the phases are different from each other as large as 180 degrees. The kneading shaft 66 and the patting shaft 67 are respectively rotated by driving the massage motors M1 and M2. The treatment element 62 performs a kneading massage by rotating the kneading shaft 66, and performs a patting massage by rotating the patting shaft 67. The arm 61 having the treatment element 62, the kneading shaft 66, and the patting shaft 67 are supported by the movable frame 60b. Therefore, the treatment element 62 can move forward to and rearward from the user via the movement of the movable frame 60b.

As illustrated in FIG. 6, the first sensor 69 which is first detection means for detecting a load received when the treatment element 62 moves has a plurality of (five in the present embodiment) non-contact type detection units 69a disposed around the output shaft M3a of the upward-downward moving motor M3 which is a drive unit, and a magnet-made detection target portion 69b whose presence/absence is detected by the detection unit 69a disposed in the output shaft M3a of the upward-downward moving motor M3. The detection unit 69a can detect a rotation position of the output shaft M3a having the detection target portion 69b. More specifically, the detection unit 69a can recognize the rotation position of the output shaft M3a at a plurality of positions (five positions in the present embodiment). The first sensor 69 detects a rotation speed of the upward-downward moving motor M3, based on a change amount of the rotation position of the output shaft M3a within a predetermined time. The massage unit 8 moves upward or downward along the height direction by driving the upward-downward moving motor M3. However, when the control unit 9 drives the upward-downward moving motor M3, the control unit 9 drives the upward-downward moving motor M3 so as to set a target rotation speed for a plurality of predetermined speeds illustrated in FIG. 7. The target rotation speed corresponding to each speed is stored in the storage unit 50. For example, as illustrated in FIG. 7, the upward-downward moving motor M3 is driven so that a speed 1 of the upward-downward moving motor M3 is 10 revolutions per second of the target rotation speed, so that a speed 2 is 15 revolutions per second of the target rotation speed, so that a speed 3 is 20 revolutions per second of the target revolution speed, so that a speed 4 is 25 revolutions per second of the target revolution speed, and so that a speed 5 is 30 revolutions per second of the target revolution speed. That is, in a case where the speed 1 and the speed 5 are compared with each other, the upward or downward moving speed along the height direction of the massage unit 8 is slow at the speed 1, and is fast at the speed 5. In the above description, the target rotation speed for a plurality of the predetermined speeds is set. However, the present invention is not limited thereto. At least one predetermined speed may be set, and at least one target rotation speed may be used. In this way, the first sensor 69 (to be described later) detects that the rotation speed of the driven upward-downward moving motor M3 is lowered as much as a prescribed value or greater from one target rotation speed. In this manner, the first sensor 69 can detect the fact as a load.

The first sensor 69 can detect the rotation speed of the upward-downward moving motor M3 as described above. In the control unit 9, when the driving of the upward-downward moving motor M3 is controlled so that the rotation speed of the upward-downward moving motor M3 coincides with the target rotation speed, in a case where the user does not lean on the backrest unit 3, the treatment element 62 is in an unloaded state. Accordingly, the rotation speed of the upward-downward moving motor M3 coincides with the target rotation speed. However, if the user leans on the backrest unit 3 and the treatment element 62 comes into contact with the back of the user, the load is applied when the treatment element 62 moves, that is, the load is applied to the driving of the upward-downward moving motor M3, and thus, the rotation speed of the upward-downward moving motor M3 is lowered to be slower than the target rotation speed. In a case where the rotation speed is lowered as much as the prescribed value or greater, the first sensor 69 can detect the fact as the load. For example, when the massage unit 8 is located at an initial position (in the vicinity of the head where the user leans on the backrest unit 3), the user is not in contact with the treatment element 62. Accordingly, the treatment element 62 is in an unloaded state. When the treatment element 62 moves downward from the initial position in this unloaded state, the rotation speed of the upward-downward moving motor M3 coincides with the target rotation speed. If the treatment element 62 comes into contact with the shoulder of the user in the downward moving process, a prescribed or greater load is applied to the treatment element 62. Accordingly, the rotational speed of the upward-downward moving motor M3 is lowered, and does not coincide with the target rotation speed. In a case where the first sensor 69 detects that the rotation speed of the upward-downward moving motor M3 is lowered as much as the prescribed value or greater, it is assumed that the load is applied. In this manner, the upper and lower position of the massage unit 8 to which the load is applied can be detected as a shoulder position of the user.

The arm 61 can freely oscillate in the forward-rearward direction, and is biased by spring-made biasing means (not illustrated) so that the treatment element 62 on the upper side protrudes forward. The massage unit 8 has a second sensor 70 which is second detection means for detecting a specific site of the body of the user, based on the movement of the massage unit 8 in the height direction. The second sensor 70 can detect the specific site of the body by detecting that the arm 61 is located at a predetermined oscillation position while the massage unit 8 is moving toward the shoulder position of the user detected by the first sensor 69. More specifically, if the treatment element 62 on the upper side reaches above the shoulder in the process where the massage unit 8 moves upward along the height direction, the load is no longer applied to the treatment element 62, and the arm 61 oscillates forward so as to be located at the predetermined oscillation position. The second sensor 70 detects that the arm 61 is located at the predetermined oscillation position, and detects the shoulder position, based on the upper and lower position of the massage unit 8 at that time. Based on the shoulder position, positions of other sites (neck, back, or waist) are obtained by calculation. The shooter position which is the detected specific site is stored in the storage unit 50.

### Configuration of Side Wall Portion

As illustrated in FIGS. 1 to 3, a side wall portion 7 disposed to face the outer surface of the shoulder or the upper arm of the user is disposed on the right and left sides of the back frame 3a (backrest unit 3). The side wall portion 7 is erected forward on the side of the backrest unit 3. The inner surface of the side wall portion 7 has a shoulder side massage unit a2 for performing the massage on the outer surface of the shoulder or the upper arm. The shoulder side massage unit a2 is configured to include an air cell 20 inflated and deflated by supplying and discharging the air. In this way, the shoulder side massage units a2 form a pair on the right and left, thereby configuring a massage unit group A2.

### Configuration of Pillow Unit

As illustrated in FIGS. 1 to 3, the upper front surface of the backrest unit 3 has a pillow unit 5 which supports the head and/or the neck of the user. The front surface of the pillow unit 5 has a pair of right and left head massage units a1 disposed to face the rear surface of the head and/or the neck. The head massage unit a1 is configured to include the air cell 20 inflated and deflated by supplying and discharging the air. In this way, the head massage units a1 form a pair on the right and left, thereby configuring a massage unit group A1. The head massage unit a1 may be disposed to face the outer surface of the head and/or the neck. In this case, it is preferable to dispose the head massage unit a1 on an inner surface of a wall portion (not illustrated) erected forward. In addition, the head massage unit a1 may not be disposed in the pillow unit 5, and may be directly disposed on the upper front surface of the backrest unit 3.

### Configuration of Armrest Unit

As illustrated in FIGS. 1 to 3, the armrest unit 6 which supports the fingers and the forearm of the user is disposed on both the right and left sides of the seat unit 2. Arm massage units a3 are disposed in the upward-downward direction of the fingers and the forearm in the armrest unit 6. The arm massage units a3 are configured to include the air cell 20 inflated and deflated by supplying and discharging the air. In this way, the arm massage units a3 form a pair on the right and left, thereby configuring a massage unit group A3.

### Configuration of Footrest

As illustrated in FIGS. 1 to 3, the footrest 4 has a pair of right and left leg support portions 40 for supporting the lower thigh of the user, and a pair of right and left foot support portions 41 for supporting the feet of the user. The leg support portion 40 has a bottom wall 40a disposed to face the rear surface of the lower thigh of the user, side walls 40b erected forward from both right and left ends of the bottom wall 40a, and a central wall 40c erected forward from the center in the rightward-leftward direction of the bottom wall 40a.

The inner surface of the side wall 40b has a leg massage unit a6 for performing the massage on the outer surface of the lower thigh. Both the outer surfaces of the central wall 40c have the leg massage unit a6 for performing the massage on the inner surface of the lower thigh of the user. In addition, the bottom wall 40a has a leg massage unit a7 for performing the massage on the lower thigh of the user from the rear surface. The leg massage units a6 and a7 are configured to include the air cell 20 inflated and deflated by supplying and discharging the air. The leg massage units a6 configure a massage unit group A6 in such a way that the leg massage unit a6 facing the inner surface of the lower thigh and the leg massage unit a6 facing the outer surface of the lower thigh form a pair on the right and left. The leg massage units a7 configure a massage unit group A7 in such a way that the leg massage unit a7 facing the rear surface of the left side lower thigh across the central wall 40c and the leg massage unit a7 facing the rear surface of the right side lower thigh across the central wall 40c form a pair on the right and left.

The foot support portion 41 has a bottom wall 41a on which the sole of the user is placed, side walls 41b erected upward from both right and left ends of the bottom wall 41a, a central wall 41c erected upward from the center in the rightward-leftward direction of the bottom wall 41a, and a rear wall 41d facing the rear surface (vicinity of the heel) of the foot portion erected upward from the rear portion of the bottom wall 41a. A recess portion 42 which is open upward and forward from the respective walls 41a to 41d is formed so that the foot portion can be accommodated in the recess portion 42.

The respective walls 41a to 41c have foot massage units a8 for performing the massage on the feet of the user. The foot massage units a8 form a pair on the right and left, thereby configuring a massage unit group A8. The foot massage unit a8 is configured to include the air cell 20 inflated and deflated by supplying and discharging the air.

### Configuration of Controller

As illustrated in FIGS. 1 to 4, the upper portion of the armrest unit 6 includes the controller 10 so as to be operable in a state where the user sits thereon. The controller 10 has a screen 10a which can be visibly checked by the user, a touch panel 10b operated by the fingertip of the user on the screen 10a, and a speaker 33a which is a notification unit 33 which notifies the user of the specific site detected by the second detecting means by using voice. An example has been described in which the controller 10 has the speaker 33a. However, the present invention is not limited thereto. The speaker 33a may be disposed in the upper portion (in the vicinity of the ear when the user sits thereon) of the above-described backrest unit 3 or the above-described pillow unit 5. In addition, in the above description, an example has been described in which the notification unit 33 is the speaker 33a. However, the present invention is not limited thereto. The specific site of the user which is detected by the second detecting means may be notified to the user, and may be displayed on the screen 10a of the controller 10. In this way, the user can recognize the specific site during the massage. For example, the user can recognize the shoulder position suitable for the user himself or herself during the massage. In addition, the user operates the controller 10 for reclining so that a posture of the backrest unit 3 can be changed. The footrest 4 is caused to oscillate upward and downward so that the posture of the footrest 4 can be changed. In addition, the massage unit 8 and the respective massage units a1 to a8 to be operated can be selected, or the position of the operation (procedure or strength) of the massage unit 8 and the respective massage units a1 to a8 can be changed. Instead of the operation using the touch panel 10b, only a physical button 31 located inside the controller 10 may be operated. Alternatively, only a voice recognition unit 32 using a microphone (not illustrated) installed inside the controller 10 may be operated. In this way, the user can easily select any option. The microphone (not illustrated) which is the voice recognition unit 32 may not be installed inside the controller 10, and may be installed in the upper portion of the backrest unit 3 or in the pillow unit 5. In this manner, the user can select any option by using the voice recognition unit 32 while leaning on the backrest unit 3 without having to bother to change the posture.

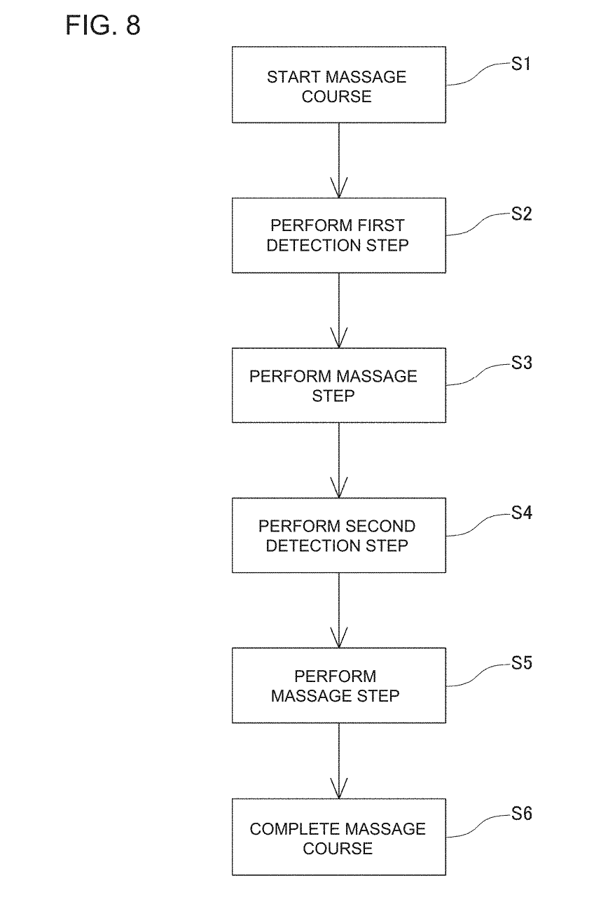

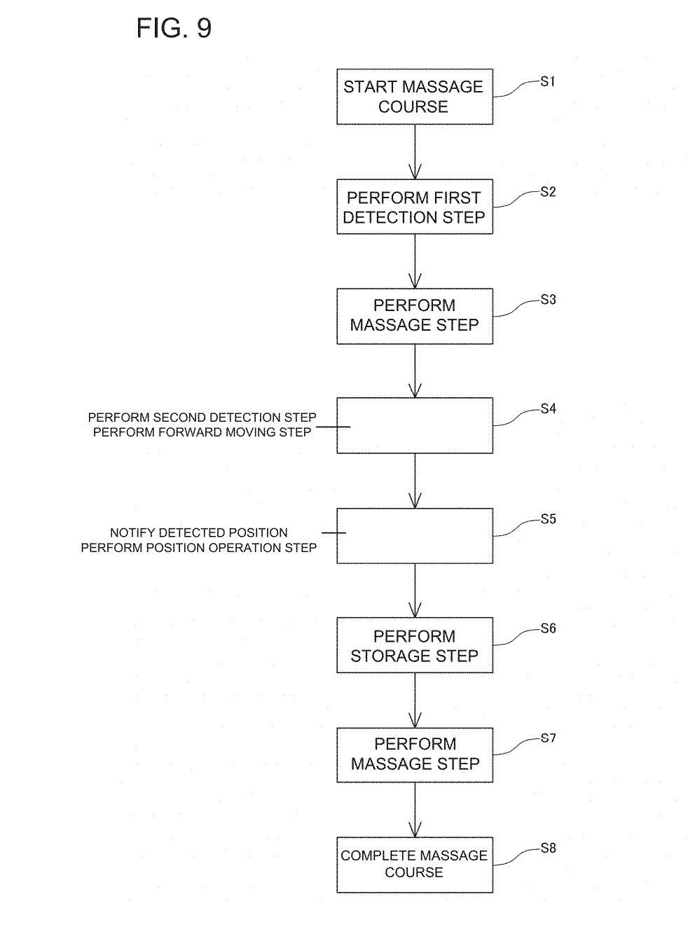

Hereinafter, a massage course of the massage machine 1 will be described. FIGS. 8 to 9 are flowcharts illustrating the massage course of the massage machine 1.

Hereinafter, a series of flows in the massage course of the massage machine 1 will be described with reference to FIG. 8.

The control unit 9 operates the controller 10 so as to start a selected massage course. (Step S1). Subsequent to Step S1, in the process of moving the massage unit 8 from an initial position, a first detection step of causing first detection means to detect the specific site of the user to which a load is applied is performed. (Step S2) The first detection step performed in Step S2 will be specifically described. If the massage course starts, the massage unit 8 moves downward from the initial position (vicinity of the head portion where the user leans on the backrest 3). The initial position of the massage unit 8 is located in the vicinity of the head portion of the backrest unit 3, and the treatment element 62 is located at a position which is not in contact with the user. Since the treatment element 62 is not in contact with the user, the treatment element 62 is in an unloaded state. The treatment element 62 moves downward from the initial position in the unloaded state, and comes into contact with the user at the shoulder position of the user. The treatment element 62 comes into contact with the user. Accordingly, a prescribed or greater load is applied to the treatment element 62, thereby enabling the first sensor 69 to detect the load. The upper and lower position of the massage unit 8 to which the load is applied can be detected as a temporary shoulder position.

Subsequent to Step S2, a massage step of causing the massage unit 8 to perform the massage is performed after the first detection step. (Step S3) Specifically, in the massage step, the massage is performed by moving the massage unit 8 downward from the shoulder position temporarily detected in the first detection step. The kneading massage or the patting massage is performed on the back or waist position. The back or waist position can be calculated, based on the shoulder position temporarily detected in the first detection step.

Subsequent to Step S3, in the process of moving to the specific site of the user which is temporarily detected in the first detection step during the massage step, a second detection step of causing second detection means to detect the specific site of the user is performed. (Step S4) Specifically, the massage is performed at a position moved downward from the shoulder position temporarily detected in the first detection step during the massage step. In the process of moving upward to the shoulder position during the massage, if the treatment element 62 on the upper side reaches above the shoulder, the load is no longer applied to the treatment element 62, and the arm 61 oscillates forward so as to be located at a predetermined oscillation position. The second sensor 70 detects that the arm 61 is located at the predetermined oscillation position. The shoulder position is detected again, based on the upper and lower position of the massage unit 8 at that time. In this way, the position misalignment caused by the posture change of the user is detected again during the massage. In this manner, an accurate shoulder position can be detected again. In addition, based on the shoulder position, positions of other sites (neck, back, or waist) are obtained by calculation. In this manner, the massage is performed for each site in the subsequent massage step.

Subsequent to Step S4, the massage step is performed. (Step S5) Specifically, the massage is performed on each calculated site by the massage unit 8. Subsequent to Step S5, the massage operation is completed in the massage step, thereby completing the massage course. (Step S6) In this way, the massage course for performing a series of steps in Steps S1 to S6 can be performed. Accordingly, the user can immediately receive the massage after the massage course starts. The massage can be performed on each site by detecting the specific site of the user while the user is not conscious of detecting the specific site during the massage.

Hereinafter, a series of flows in which a forward moving step, a position operation step, and a storage step are added to the massage course of the massage machine 1 will be described with reference to FIG. 9.

The control unit 9 operates the controller 10 so as to start the selected massage course. (Step S1) Subsequent to Step S1, in the process of moving the massage unit 8 from the initial position, the first detection step of causing the first detection means to detect the specific site of the user, to which the load is applied. (Step S2) The first detection step performed in Step S2 will be specifically described. If the massage course starts, the massage unit 8 moves downward from the initial position (vicinity of the head portion where the user leans on the backrest 3). The initial position of the massage unit 8 is located in the vicinity of the head portion of the backrest unit 3, and the treatment element 62 is located at a position which is not in contact with the user. Since the treatment element 62 is not in contact with the user, the treatment element 62 is in an unloaded state. The treatment element 62 moves downward from the initial position in the unloaded state, and comes into contact with the user at the shoulder position of the user. The treatment element 62 comes into contact with the user. Accordingly, a prescribed or greater load is applied to the treatment element 62, thereby enabling the first sensor 69 to detect the load. The upper and lower position of the massage unit 8 to which the load is applied can be detected as a temporary shoulder position.

Subsequent to Step S2, the massage step of causing the massage unit 8 to perform the massage is performed after the first detection step. (Step S3) Specifically, in the massage step, the massage is performed by moving the massage unit 8 downward from the shoulder position temporarily detected in the first detection step. The kneading massage or the patting massage is performed on the back or waist position. The back or waist position can be calculated, based on the shoulder position temporarily detected in the first detection step.

Subsequent to Step S3, in the process of moving to the specific site of the user which is temporarily detected in the first detection step during the massage step, the second detection step of causing the second detection means to detect the specific site of the user and the forward moving step of causing forward-rearward moving means to move the massage unit forward are performed. (Step S4) Specifically, the massage is performed at a position moved downward from the shoulder position temporarily detected in the first detection step during the massage step. In the process of moving upward to the shoulder position during the massage, the air cell 20a is inflated, and the movable frame 60b is moved forward in the forward-rearward direction around the oscillation shaft 64, thereby causing the treatment element 62 to move forward. In this way, the treatment element 62 can be moved upward along the back of the user, and the shoulder position can be more remarkably detected. If the treatment element 62 on the upper side reaches above the shoulder, the load is no longer applied to the treatment element 62, and the arm 61 oscillates forward so as to be located at a predetermined oscillation position. The second sensor 70 detects that the arm 61 is located at the predetermined oscillation position. The shoulder position is detected again, based on the upper and lower position of the massage unit 8 at that time. In this way, the position misalignment caused by the posture change of the user is detected again during the massage. In this manner, an accurate shoulder position can be detected again. In addition, based on the shoulder position, positions of other sites (neck, back, or waist) are obtained by calculation. In this manner, the massage is performed for each site in the subsequent massage step. In the above description, an example has been described in which the forward moving step is performed in the second detection step. However, the present invention is not limited thereto. The forward moving step may be performed during the first detection step in Step S2. In this way, the shoulder position can be more remarkably detected. In addition, the forward moving step may be performed in Step S3 or during the massage step in Step S7 (to be described later). In this manner, the user can enjoy a more comfortable feeling during the massage.

Subsequent to Step S4, the specific site detected by performing the second detection step is notified to the user, and the position operation step is performed which enables the massage unit to be located at any desired position from the specific site by performing a manual operation. (Step S5) Specifically, the shoulder position detected in the second detection step is notified to the user by the speaker 33a which is the notification unit 33. For example, a message of “The massage is now performed on the shoulder now. Is the massage unit aligned with the shoulder position? Please adjust the alignment in a case where the adjustment is needed” is notified to the user so as to recognize the alignment. In a case where the shoulder position is not a suitable position, the user operates the above-described controller 10 so as to adjust the upper and lower position of the massage unit 8 in the position operation step. Therefore, the user can adjust and determine the shoulder position by himself or herself.

Subsequent to Step S5, the storage step of causing the storage unit 50 to store the position determined by performing the manual operation in the position operation step as the specific site is performed. (Step S5) Specifically, the storage unit 50 stores the shoulder position moved by the own operation of the user in the position operation step, and calculates each site again, based on the shoulder position. In this way, the massage can be suitably performed on each site in the subsequent massage step.

Subsequent to Step S6, the massage step is performed. (Step S7) Specifically, the massage is performed on each calculated site described above by the massage unit 8. Subsequent to Step S7, the massage operation is completed in the massage step, thereby completing the massage course. (Step S8) In this way, the massage course for performing a series of steps in Steps S1 to S8 can be performed. Accordingly, the user can immediately receive the massage after the massage course starts. The massage can be performed on each site by detecting the specific site of the user while the user is not conscious of detecting the specific site during the massage.

### Another Embodiment

Alternatively, without being limited to the illustrated embodiment, the massage machine 1 according to the present invention may adopt another embodiment within the scope of this invention.

For example, in the above-described embodiment, an example has been described in which the invention is effectively applicable to the position misalignment caused by the movement of the user himself or herself. However, after the posture of the backrest unit 3 or the footrest 4 is changed by the first actuator 11 or the second actuator 12, the second detection step may be performed. In this way, the massage can be suitably performed on each site after the posture of the backrest unit 3 or the footrest 4 is changed.

The present invention is applicable to the massage machine which enables the user to immediately receive the massage, and which can detect the specific site of the user while the user is not conscious of detecting the specific site during the massage.

Hereinbefore, the present invention has been described with reference to the embodiments, but the present invention is not limited thereto. It is obvious to those skilled in the art that various modifications, replacements, combinations and the like may be made, for example. It should be understood that the invention is not limited to the above-described embodiment, but may be modified into various forms on the basis of the spirit of the invention. Additionally, the modifications are included in the scope of the invention.

What is claimed is:

1. A massage machine comprising:
a backrest unit on which a user is configured to lean;
a massage unit that is disposed in the backrest unit configured to perform a massage on the user; and
a control unit configured to control the massage unit,
wherein the massage unit is movable in a height direction and comprises:
a treatment element that is configured to apply treatment onto the user,
a first sensor configured to detect a first site of the user based on a load received from the user according to a movement of the massage unit and
a second sensor configured to detect a second site of the user based on a movement of the treatment element according to the movement of the massage unit;
wherein the control unit is configured to control the massage unit that:
the first sensor detects the first site of the user during the movement of the massage unit from an initial position,
the second sensor detects the second site of the user during the massage being in progress.

2. The massage machine according to claim 1,
the second sensor detects the second site during the movement of the massage unit toward the first site.

3. The massage machine according to claim 1,
the first site is a shoulder position of the user.

4. The massage machine according to claim 3,
the second site is a shoulder position of the user.

5. The massage machine according to claim 1, further comprising:
a drive unit that moves the treatment element in the height direction,
wherein the first sensor detects a load of the drive unit.

6. The massage machine according to claim 1, further comprising:
forward-rearward moving means for moving the massage unit forward and rearward,
wherein the control unit is configured to control the forward-rearward moving means to move the massage unit forward.

7. The massage machine according to claim 6,
wherein the forward-rearward moving means is an air cell.

8. The massage machine according to claim 1, further comprising:
a notification unit that notifies the user by voice,
wherein the control unit controls the notification unit configured to notify the user of the second site.

9. The massage machine according to claim 1, further comprising:
a storage unit,
wherein the control unit configured to perform a manual operation so as to enable the massage unit to be located at any desired position from the second specific site, and to cause the storage unit to store the position located by performing the manual operation as the second specific site.
